(19) United States
(12) Patent Application Publication
(10) Pub. No.: US 2009/0138650 A1
(43) Pub. Date: May 28, 2009

(54) METHOD AND APPARATUS FOR MANAGING FIRMWARE OF AN OPTICAL STORAGE APPARATUS

(76) Inventors: Yen-Cheng Lin, Kaohsiung City (TW); Shr-Cheng Li, Taipei City (TW); Yih-Shin Weng, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/945,254

(22) Filed: Nov. 26, 2007

(51) Int. Cl. G06F 12/00

(52) U.S. Cl. 711/103; 711/E12.008

(57) ABSTRACT

A method of managing a firmware includes configuring the firmware to include at least a first firmware portion with a plurality of program codes, and a second firmware portion with a plurality of parameters separately; and storing the first firmware portion and the second firmware portion in a first storage area and a second storage area of a first storage module, respectively.

### BACKGROUND

The present invention relates to managing firmware of an electronic apparatus, and more particularly, to a method and system for managing firmware of an optical storage apparatus.

The typical optical storage apparatus supports some types of optical storage mediums, and the typical optical storage apparatus utilizes a code bank of programs to store code tables for obtaining needed parameters for recording data to or reading data from a loaded optical storage medium (e.g., an optical disc). However, if optical storage apparatus needs to access different types of optical storage media or update the supported types of optical storage media or adjust reading/recording parameters, all of the firmware of optical storage apparatus must be updated.

In general, the program and the data are combined in the firmware of the conventional optical storage apparatus. As a result, the user has to take the risk of firmware update failure, in addition to the rather time-consuming task of updating all firmware of optical storage apparatus.

### SUMMARY

Therefore, one of the objectives of the present invention is to provide a method and memory management apparatus of managing a firmware of an optical storage apparatus.

According to an embodiment of the present invention, a method of managing a firmware of an optical storage apparatus is disclosed. The method includes: configuring the firmware to include at least a first firmware portion with a plurality of program codes, and a second firmware portion with a plurality of parameters separately; and storing the first firmware portion and the second firmware portion in a first storage area and a second storage area of a first storage module respectively.

According to another embodiment of the present invention, a memory management apparatus of managing a firmware of an optical storage apparatus is provided. The memory management apparatus includes: a processor; a first storage module, coupled to the processor, for storing the firmware; and a second storage module, for storing temporary data copied from the first storage module. The first storage module includes a first storage area for storing a first firmware portion with a plurality of program codes, and a second storage area for storing a second firmware portion with a plurality of parameters.

According to another embodiment of the present invention, a memory management apparatus of managing a firmware of an optical storage apparatus is provided. The memory management apparatus includes: a processor, a first storage module, a second storage module, and a third storage module. The first storage module is coupled to the processor for storing a first firmware portion with a plurality of program codes. The second storage module is coupled to the processor for storing a second firmware portion with a plurality of parameters. The third storage module is used to store temporary data copied from the first storage module or the second storage module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a memory management apparatus according to an embodiment of the present invention.

FIG. 2 is a flowchart illustrating a method for managing a firmware of an optical storage apparatus according to an embodiment of the present invention.

FIG. 3 is a flowchart illustrating a method for managing a firmware of an optical storage apparatus according to another embodiment of the present invention.

FIG. 4 is a flow chart of reading firmware of an optical storage apparatus according to another embodiment of the present invention.

FIG. 5 is a simplified diagram illustrating a memory arrangement of a first storage module shown in FIG. 1.

FIG. 6 is a block diagram illustrating a memory management apparatus according to another embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

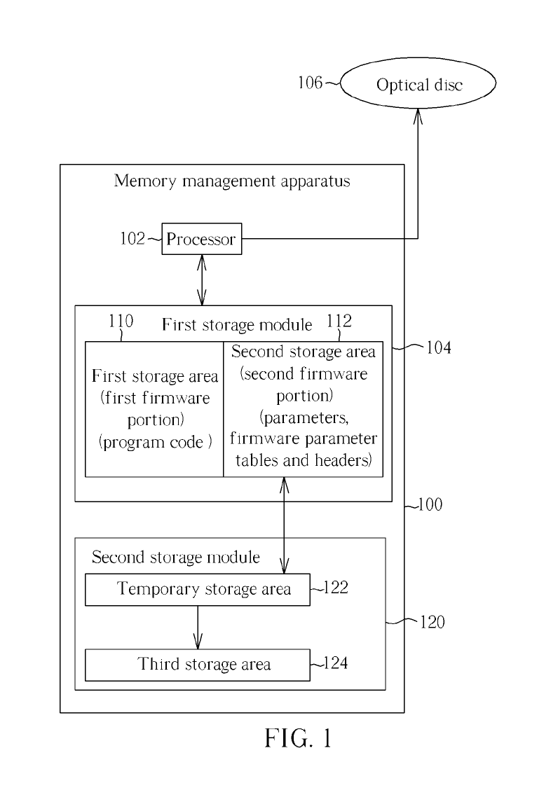

Please refer to FIG. 1. FIG. 1 is a block diagram illustrating a memory management apparatus 100 according to an embodiment of the present invention. In this embodiment, the memory management apparatus 100 is used for an optical storage apparatus (not shown), such as an optical disc drive, to access (reading data from or writing data to) an optical disc 106. The memory management apparatus 100 has a processor 102, a first storage module 104, and a second storage module 120. The first storage module 104 has a first storage area 110 and a second storage area 112. The second storage module 120 has a temporary storage area 122 and a third storage area 124. It should be noted that only the components pertinent to the present invention are shown in FIG. 1 for simplicity.

Accordingly, the processor 102 fetches and executes the firmware to control operation of the optical storage apparatus. For example, the processor 102 obtains identification information from the optical disc 106 by instructing a disc access mechanism including an optical pick-up head, a servo system, etc. The retrieved identification information has, but is not limited to, a book type for indicating what the physical format of the optical disc 106 is, and/or a speed range (for example, 16×, 32×, 48×, 52× or 64×).

The first storage area 110 includes a first firmware portion with at least one program code and a plurality of addresses respectively corresponding to headers of the firmware parameter tables stored in the second storage area 112. The first storage module 104 is, but is not limited to, a firmware memory (e.g., a Flash ROM or any non-volatile storage), and the second storage module 120 is, but is not limited to, a dynamic random access memory (DRAM) or other volatile storage.

The second storage area 112 has a second firmware portion with at least one parameter and the firmware parameter tables each having at least one parameter. In one embodiment of the present invention, the second firmware portion is encoded or encrypted before being stored into the second storage area 112, whereby the second firmware portion, including the control information of the optical storage apparatus, is protected against unauthorized access. The firmware parameter tables include, but are not limited to, a disc code table, a writing storage register (WSR) table, and an optimum power calibration (OPC) table.

Please note that the above-mentioned disc code table, the WSR table and the OPC table are not all stored in a code bank (i.e. the first storage area 110) of the conventional program code, but further are stored in the second storage area 112 separately from the program code stored in the first storage area 110, i.e., the parameters are stored in an out-of-bank manner. Therefore, in most cases of firmware updating, the user can only update the second firmware portion by storing the program code and parameters separately (i.e., out of bank updating).

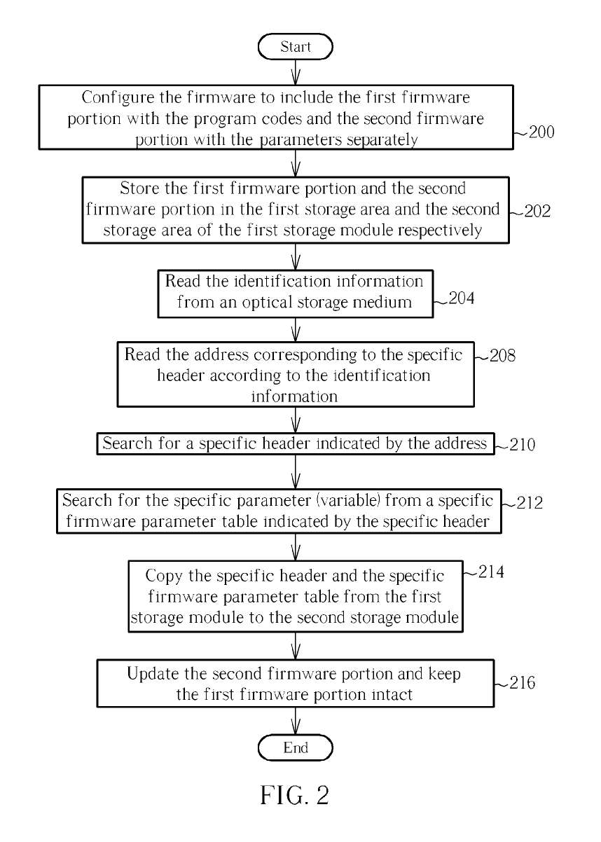

Please refer to FIG. 2 in conjunction with FIG. 1. FIG. 2 is a flowchart illustrating a method for managing a firmware of an optical storage apparatus according to an embodiment of the present invention. In Step 200, the processor 102 configures the firmware to include the first firmware portion with the program codes and the second firmware portion with the parameters separately. Then, in Step 202, the processor 102 stores the first firmware portion and the second firmware portion in the first storage area 110 and the second storage area 112 of the first storage module 104, respectively. The processor 102 firstly encodes the second firmware portion before storing the second firmware portion into the second storage area 112.

In Step 204, the processor 102 reads identification information from an optical storage medium (e.g., the optical disc 106 shown in FIG. 1), wherein the identification information has a book type or a speed range of the optical storage medium. Then, the processor 102 searches for a specific parameter stored in the second storage area 112 according to the identification information through a specific header. The specific parameter (variable) can be the disc code parameter, the WSR parameter or the OPC parameter. The processor 102 decodes the second firmware portion before searching for the specific parameter.

It should be noted that, the second firmware portion stored in the second storage area 102 has the firmware parameter tables (e.g., the disc code table, the WSR table or the OPC table) each has at least one parameter and several headers (e.g., the disc code header, the WSR header or the OPC header). The headers indicate the storage locations of the firmware parameter tables, respectively. Furthermore, the first firmware portion stored in the first storage area 110 has at least one address corresponding to the aforementioned header.

The procedure to search for the specific parameter through the specific header is described as steps 208˜212. In Step 208, the processor 102 reads the address corresponding to the specific header according to the identification information. Then, in Step 210, the processor 102 searches for the specific header indicated by the above-mentioned address. Following Step 210, in Step 212, the processor 102 searches for the aforementioned specific parameter (variable) indicated by the specific header.

Furthermore, in Step 214, the processor 102 copies the above-mentioned specific header and the above-mentioned specific firmware parameter table from the first storage module 104 to the second storage module 120. Lastly, in Step 216, the processor 102 updates the firmware of the optical storage apparatus by updating the second firmware portion stored in the second storage area 112, and keeps the first firmware portion stored in the first storage area 110 intact. In other words, only the second firmware portion of the above-mentioned second storage area 112 is updated.

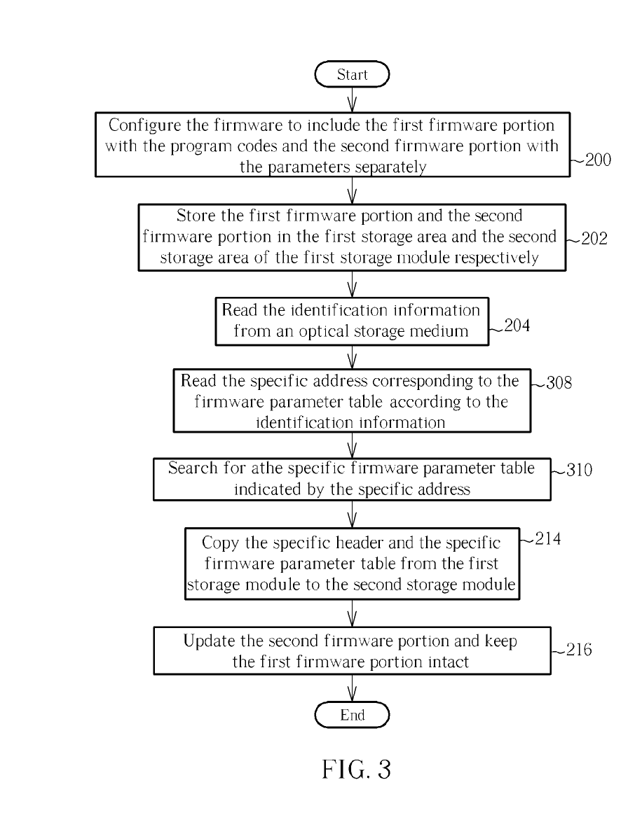

FIG. 3 is a flowchart illustrating a method for managing a firmware of an optical storage apparatus according to another embodiment of the present invention. FIG. 3 is similar to FIG. 2 except that the processor 102 searches for a specific parameter table stored in the second storage area 112 according to the identification information through a specific address.

It should be noted that, the second firmware portion stored in the second storage area 102 has the firmware parameter tables each has at least one parameter and several headers. Furthermore, the first firmware portion stored in the first storage area 110 has several addresses corresponding to the aforementioned firmware parameter tables respectively.

The procedure to search for the specific parameter table through the specific address is described as steps 308˜310. In Step 308, the processor 102 reads the specific address corresponding to the firmware parameter table (e.g. the disc code table, the WSR table or the OPC table) according to the identification information. Subsequently, in Step 310, the processor 102 searches for the specific firmware parameter table indicated by the specific address.

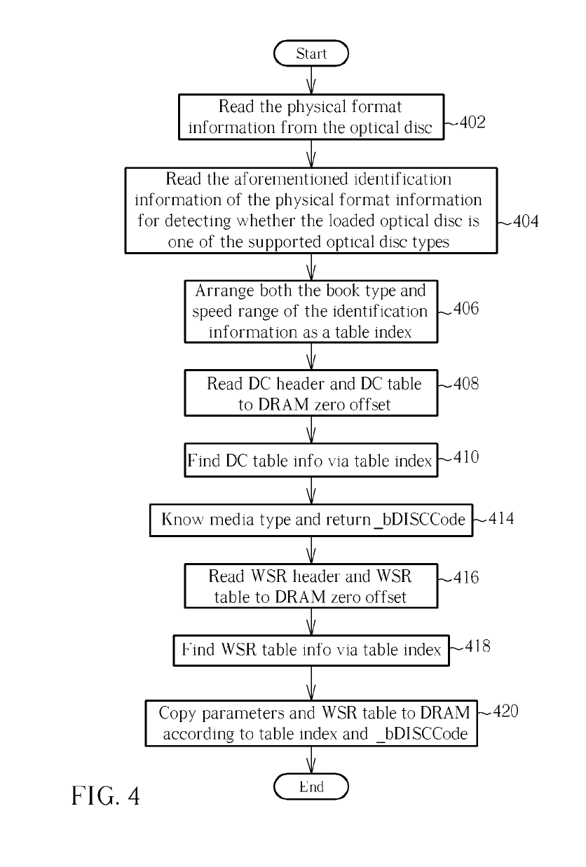

FIG. 4 is a flow chart showing the procedure of reading the firmware of an optical storage apparatus according to another embodiment of the present invention. Please refer to FIG. 4 in conjunction with FIG. 1. First, in Step 402, the processor 102 fetches and executes the program code of the first firmware portion from the first storage area 110 to read the physical format information from the optical disc 106, where the physical format information recorded on the optical disc 106 includes the above-mentioned identification information.

Next, in Step 404, the processor 102 executes the program code to read the aforementioned identification information, for example a drive manufacturer ID, stored in a bit portion (for example, from the 19th bit to the 30th bit) of the retrieved physical format information for detecting whether the loaded optical disc 106 is one of the supported optical disc types. If the aforementioned detection result is ‘false’, then the above-mentioned optical disc 106 is not supported by the optical storage apparatus; otherwise, a following Step 406 will be performed. In Step 406, both the book type and speed range of the identification information are arranged as a table index used in the following steps.

Next, the processor 106 executes the program code to read the address stored in the first storage area 110 according to the identification information, search for a specific header indicated by the address, and decode or decrypt the second firmware portion (if the second firmware portion is encoded or encrypted). In addition, the program code executed by the processor 106 searches for the specific parameter from a specific firmware parameter table; for example, the disc code table indicated by the specific header in the second firmware portion of the second storage area 112. The related operation is detailed below.

In Step 408, the processor 106 executes the program code to read and copy the specific header (e.g. the disc code header, DC header) and the specific firmware parameter table (e.g., the disc code table, DC table) from the second storage area 112 of the first storage module 104 to an offset of the temporary storage area 122 of the second storage module 120, for example DRAM (dynamic random access memory). The offset is zero, but, as is explained later, the offset is not limited to be zero. Subsequently, in Step 410, the processor 106 executes the program code to find the information from the disc code table in the temporary storage area 122 of the second storage module 120 via the table index, to obtain at least a specific parameter in the disc code table. Therefore, in Step 414, the processor 102 obtains the media type of the optical disc 106 (for example, the book type and the speed range), and returns a variable, for example _bDISCCode, to the program code of the first firmware portion stored in the first storage area 110.

Additionally, the processor 106 further executes the program code to read another address stored in the first storage area 110 according to the identification information, search for a specific header indicated by the address, and then search for a specific parameter from a specific firmware parameter table (for example, the WSR table indicated by the specific header). The related operation is detailed below.

In Step 416, the processor 106 executes the program code to read and copy the specific header (e.g. the WSR header) and the associated specific firmware parameter table (e.g., the WSR table) from the second storage area 112 of the first storage module 104 to an offset of the temporary storage area 122 (e.g., the DRAM zero offset) of the second storage module 120. Here, the offset is, but is not limited to, zero. Next, in Step 418, the program code executed by the processor 106 finds the information of the WSR table in the temporary storage area 122 of the second storage module 120 via the table index, to obtain at least a specific parameter in the WSR table. Lastly, in Step 420, the processor 106 executes the program code to copy parameters of the WSR table and the WSR table stored in the temporary storage area 122 to the third storage area 124 in the second storage module 120 (for example DRAM), according to the table index and the aforementioned variable (e.g. bDISCCode).

According to another embodiment of the present invention, the first firmware portion stored in the first storage area 110 has a plurality of addresses corresponding to the firmware parameter tables, respectively. The firmware parameter tables are, for example, the disc code table, the WSR table and the OPC table. After Step 406 and Step 414, the processor 106 executes the program code to read a specific address according to the identification information, and search for a specific firmware parameter table (for example, the disc code table or the WSR table) indicated by the specific address. Then, in Step 408 and Step 416, the processor 106 executes the program code to read and copy the specific firmware parameter table from the second storage area 112 of the first storage module 104 to an offset of the temporary storage area 122 of the second storage module 120.

Please note that, compared to the first storage module 104, the second storage module 120 is a faster data access speed memory. That is, the access speed of the second storage module 120 (such as a DRAM) is faster than the first storage module 104 (such as a Flash ROM). As a result, the exemplary embodiment of the present invention above copies the aforementioned table into the second storage module 120 for accelerating the searching operation and shortening the operation time of locating desired firmware parameters.

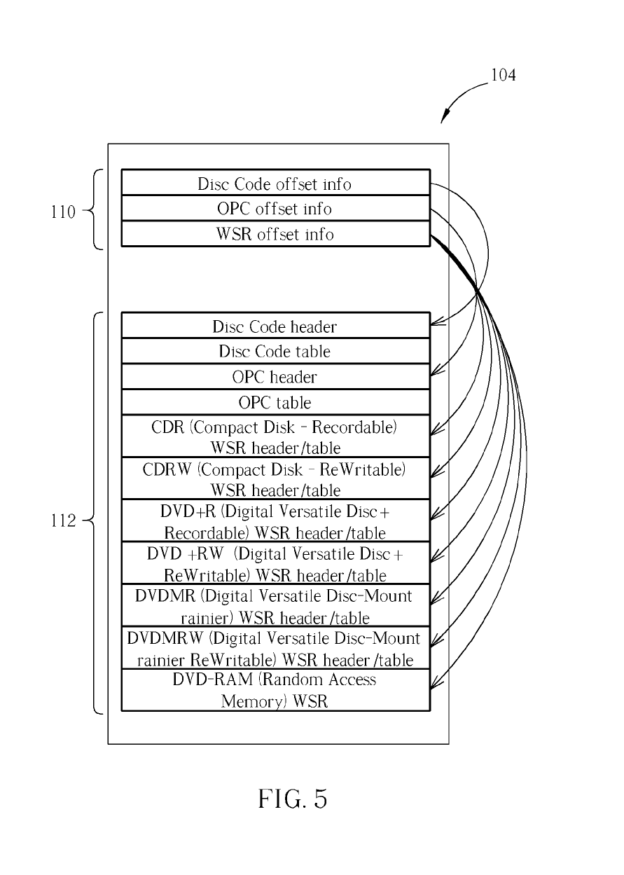

Please refer to FIG. 5. FIG. 5 is a simplified diagram illustrating a memory arrangement of the first storage module 104 shown in FIG. 1. As shown in FIG. 5, the first storage module 104 includes the first storage area 110 configured to store above-mentioned addresses and the second storage area 112 configured to store the above-mentioned disc code/OPC/WSR headers and firmware parameter tables.

The first storage module 104 stores the disc code, OPC and WSR offset information, wherein the disc code offset records an address indicative of the starting memory address of the disc code header; the OPC offset records an address indicative of the starting memory address of the OPC header; and the WSR offset records an address indicative of the starting memory address of the WSR header.

The above offsets are assigned in a file as a bin file at the time of compiling for recording address information of the headers. For example, the disc code offset in the bin file indicates that the header of the disc code table begins from an offset 0x0000h in the second storage area 112, and the header of the disc code table further indicates that the disc code table begins from an offset 0x1000h in the second storage area 112. In this way, the desired firmware parameter table can be easily accessed using the above-mentioned scheme. Briefly summarized, the aforementioned offsets indicate the allocations of the respective headers, and the headers respectively indicate the allocation of the disc code table, the WSR table and the OPC table. Each of the firmware parameter table stores parameters required for accessing (reading data from or recording data to) the loaded optical disc. In the above embodiment, the offsets (i.e., addresses indicative of locations of the headers) are not limited to be constants. With proper modifications, the offsets mentioned above can be set by variables according to design requirements.

In addition, the format of the header is illustrated by examples as described below. The format of the header of the disc code table includes, but is not limited to, at least a table index field, a start offset field, and a supported optical disc number field. The table index field is formed by the book type and the speed range, the start offset field indicates the start offset from the disc code table, and the supported optical disc number field indicates number of the optical discs supported by the optical storage apparatus.

Additionally, the format of the header of the WSR table includes, but is not limited to, at least a table index field, a start offset field of the header of the WSR table, a length field, a supported disc number field of the WSR table, a speed range field of the WSR table and an entry length field of the WSR table. Here, the table index field indicates a unique table ID for each WSR table respectively, the start offset field indicates the WSR table start offset of the location from media start address, the length field indicates the WSR table total length, the supported disc number field indicates the number of supported optical discs of the WSR table, the speed range field indicates the number of supported disc access speed of the WSR table, and the entry length field indicates the entry length of the supported disc access speed of the WSR table.

Furthermore, the format of the header of the OPC table includes, but is not limited to, a table index field, a start offset field of the header of the OPC table, a supported disc number field of the OPC table, a layer field, a speed range field of the OPC table and an entry length field of the OPC table. In the OPC table, the table index field indicates a unique table ID for each WSR table respectively, the start offset field indicates the WSR table start offset of the location from media start address, the supported disc number field indicates the number of supported optical discs of the OPC table, the layer field indicates the layer of the information stored in the optical disc, the speed range field indicates the number of the supported disc access speed of the OPC table, and the entry length field stores a word or a byte representing the entry length of the supported disc access speed in the OPC table.

Accordingly, the format of the aforementioned content is illustrated by examples as shown below. The format of the content of the disc code table includes, but is not limited to, the supported disc number field mentioned above and the entry length field. In the disc code table, the entry length field has fixed N bytes (for example, N is 12), and the N bytes comprise a disc menu ID, a media type ID and a product revision number. The format of the content of the WSR table includes, but is not limited to, at least a disc code field, a layer number field, a speed index field and an entry length field. In the WSR table, the disc code field indicates decided disc ID, the layer number field indicates located layer of the WSR table, and the speed index field and the entry length field indicate that the loaded optical disc may be an ultra speed, a high speed, a middle speed or a low speed disc. The format of the content of the OPC table includes at least the disc code field mentioned above, the layer number field mentioned above, and the speed index field mentioned above.

As shown in the FIG. 5, the aforementioned tables and headers are exemplary to be adaptive for any kinds of optical medium, such as CDR, CDRW, DVD+R, DVD-R, DVD+RW, DVD-RW, DVDMR, DVDMRW, and DVD-RAM. Moreover, the contents of the first storage module 104 (disc code, OPC and WSR offset information) are configured corresponding to the types of the optical medium. Thus, when the method of the embodiment of this invention is applied to other types of optical medium (such as Blu-ray disc), the contents of the first storage module 104 should be modified correspondingly.

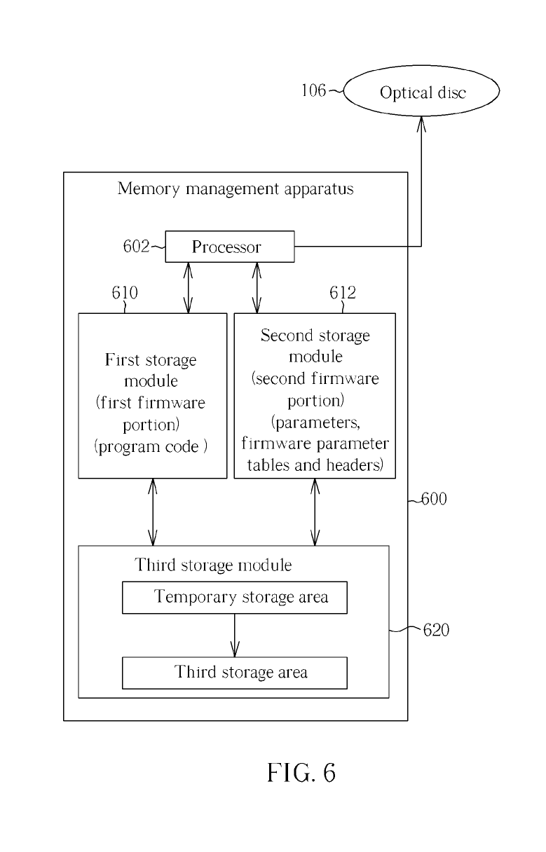

FIG. 6 is a block diagram illustrating a memory management apparatus according to another embodiment of the present invention. The memory management apparatus 600 is configured in different way from FIG. 1. Compared with FIG. 1, the first firmware portion and the second firmware portion can be configured in different storage modules respectively for the requirements of design, such as memory size and access efficiency. For example, the memory management apparatus 600 includes a processor 602, a first storage module 610, a second storage module 612, and a third storage module 620. The first storage module 610 is coupled to the processor 602 for storing the first firmware portion with the program codes. The second storage module 612 is coupled to the processor 602 for storing the second firmware portion with the parameters. The third storage module 620 is used to store temporary data copied from the first storage module 610 or the second storage module 612. It is noted that the operation of the memory management apparatus 600 is similar to the memory management apparatus 100 of FIG. 1. Therefore, there is no description for the operation of the memory management apparatus 600 for simplicity.

Please note that, if the data of the firmware in the optical storage apparatus needs to be updated, then only the second firmware portion stored in the second storage area 112 of the first storage module 104 will be updated, without modifying the first firmware portion stored in the first storage area 110. That is, the first firmware portion, including program code, remains intact when the second firmware portion is being updated. In this way, as the firmware parameters are stored out of bank, updating the firmware parameters while the program code remains intact can avoid conventional firmware updating failures. Additionally, updating the firmware parameters stored out of bank (i.e., stored in the second storage area 112 shown in FIG. 1) can be achieved by any conventional techniques, such as online firmware updating or offline firmware updating. As the online firmware updating and offline firmware updating are well known to those skilled in this art, further description is omitted here for the sake of brevity.

Those skilled in the art will readily observe that numerous modifications and alterations of the device and method may be made while retaining the teachings of the invention.

What is claimed is:

1. A method of managing a firmware of an optical storage apparatus, comprising:
configuring the firmware to include at least a first firmware portion with a plurality of program codes, and a second firmware portion with a plurality of parameters separately; and
storing the first firmware portion and the second firmware portion in a first storage area and a second storage area of a first storage module respectively.

2. The method of claim 1, further comprising:
encoding the second firmware portion before storing the second firmware portion.

3. The method of claim 1, further comprising:
reading an identification information from an optical storage medium; and
searching for a specific parameter from the second firmware portion according to the identification information.

4. The method of claim 3, further comprising:
decoding the second firmware portion before searching for the specific parameter.

5. The method of claim 3, wherein the second firmware portion comprises a plurality of firmware parameter tables each has at least one parameter and a plurality of headers indicating storage locations of the firmware parameter tables respectively.

6. The method of claim 5, wherein the first firmware portion comprises at least one address corresponding to the header.

7. The method of claim 3, wherein the step of searching for the specific parameter comprises:
reading the address according to the identification information;
searching for a specific header indicated by the address; and
searching for the specific parameter from a specific firmware parameter table indicated by the specific header.

8. The method of claim 7, wherein the step of searching for the specific parameter from the specific firmware parameter table further comprises:
copying the specific header and the specific firmware parameter table from the first storage module to a second storage module.

9. The method of claim 3, wherein the second firmware portion comprises a plurality of firmware parameter tables, each has at least one parameter, and the first firmware portion comprises a plurality of addresses corresponding to the firmware parameter tables respectively.

10. The method of claim 3, wherein the step of searching for the specific parameter comprises:
reading a specific address according to the identification information; and
searching for a specific firmware parameter table indicated by the specific address.

11. The method of claim 10, wherein the step of searching for the specific firmware parameter table comprises:
copying the specific firmware parameter table from the first storage module to the second storage module.

12. The method of claim 3, wherein the identification information comprises at least one of a book type and a speed range of the optical storage medium.

13. The method of claim 1, further comprising:
updating the second firmware portion and keeping the first firmware portion intact.

14. The method of claim 1, wherein the second firmware portion comprises the parameters only.

15. A memory management apparatus of managing a firmware of an optical storage apparatus, comprising:
a processor;
a first storage module, coupled to the processor, for storing firmware, comprising:
a first storage area, for storing a first firmware portion with a plurality of program codes; and
a second storage area, for storing a second firmware portion with a plurality of parameters; and
a second storage module, for storing temporary data copied from the first storage module.

16. The memory management apparatus of claim 15, wherein the processor encodes the second firmware portion before storing the second firmware portion.

17. The memory management apparatus of claim 15, wherein the second firmware portion comprises a plurality of firmware parameter tables each has at least one parameter and a plurality of headers indicating storage locations of the firmware parameter tables respectively.

18. The memory management apparatus of claim 17, wherein the first firmware portion comprises at least one address corresponding to the header.

19. The memory management apparatus of claim 15, wherein the second firmware portion comprises a plurality of firmware parameter tables each has at least one parameter, and the first firmware portion comprises a plurality of addresses corresponding to the firmware parameter tables respectively

20. The memory management apparatus of claim 15, wherein the second firmware portion comprises the parameters only.

21. A memory management apparatus of managing a firmware, comprising:
a processor;
a first storage module, coupled to the processor, for storing a first firmware portion with a plurality of program codes;
a second storage module, coupled to the processor, for storing a second firmware portion with a plurality of parameters; and
a third storage module, for storing temporary data copied from the first storage module or the second storage module.

22. The memory management apparatus of claim 21, wherein the processor encodes the second firmware portion before storing the second firmware portion.

23. The memory management apparatus of claim 21, wherein the second firmware portion comprises a plurality of firmware parameter tables each has at least one parameter and a plurality of headers indicating storage locations of the firmware parameter tables respectively.

24. The memory management apparatus of claim 23, wherein the first firmware portion comprises at least one address corresponding to the header.

25. The memory management apparatus of claim 21, wherein the second firmware portion comprises a plurality of firmware parameter tables each has at least one parameter, and the first firmware portion comprises a plurality of addresses corresponding to the firmware parameter tables respectively.
